(19) United States
(12) Patent Application Publication
(10) Pub. No.: US 2010/0245284 A1
(43) Pub. Date: Sep. 30, 2010

(54) Input device and electronic device using the same

(75) Inventor: Hiroyuki Ito, Gunma-ken (JP)

Correspondence Address: THE NATH LAW GROUP, 112 South West Street, Alexandria, VA, 22314, US

(73) Assignees: VICTOR COMPANY OF JAPAN, LIMITED, Yokohama-shi (JP); KABUSHIKI KAISHA KENWOOD, Tokyo (JP)

(21) Appl. No.: 12/659,969

(22) Filed: Mar. 26, 2010

(30) Foreign Application Priority Data
Mar. 27, 2009 (JP) P2009-079179

(51) Int. Cl. G06F 3/045

(52) U.S. Cl. 345/174

(57) ABSTRACT

An input device capable of detecting such a finger's adjacency to a touch panel even if a user does not touch the touch panel through a user's finger and an electronic device using the input device light are provided. In the input device, an input position detecting unit 101 detects an input position onto the touch panel 11 when a first resistive membrane 11X makes contact with a second resistive membrane 11Y of the touch panel 11. An adjacency detecting part 102 detects an adjacency of a user's finger to the touch panel 11 on the basis of an electrostatic capacitance produced between the first and the second resistive membranes 11X, 11Y and ground. A detection-mode switching control part 103 switches the operating mode of the input device between one condition where the input position detecting unit 101 is operating and another condition where the adjacency detecting part 102 is operating. A resistive membrane connecting part connects the first resistive membrane 11X with the second resistive membrane 11Y electrically when the adjacency detecting part 102 is operating.

### BACKGROUND OF THE INVENTION

1. Field of the Invention

The present invention relates to an input device having a touch panel and an electronic device using the input device.

2. Description of the Related Art

In recent years, an electronic device requiring a manipulated input with use of a resistive touch panel has been in widespread use. The resistive touch panel of its kind is adapted so as to detect a user's input position with use of two resistive membranes. Also, in an electronic device using a resistive touch panel, it is also possible to utilize the resistive membranes as adjacency sensors in order to detect a manipulating situation about the touch panel. For instance, Japanese Patent Publication Laid-open No. 2008-152468 discloses a touch panel control device where the resistive membranes of such a resistive touch panel are utilized as the adjacency sensors.

### SUMMARY OF THE INVENTION

In the touch panel control device disclosed in the above-mentioned patent document, however, if intended to detect a user's finger in non-contact with the touch panel, there arises a problem that it is difficult to precisely detect a finger's adjacency to the touch panel due to the presence of two resistive membranes as noise source.

Under the above-mentioned situation, an object of the present invention is to provide an input device capable of detecting such a finger's adjacency to the touch panel even if a user does not touch the touch panel through a user's finger and also provide an electronic device using the input device.

In order to achieve the above objects, according to the first aspect of the present invention, there is provided an input device comprising: a touch panel including a first resistive membrane and a second resistive membrane; an input position detecting unit configured to detect an input position onto the touch panel when the first resistive membrane makes contact with the second resistive membrane, the input position detecting unit being connected with the touch panel electrically; an adjacency detecting part configured to detect an adjacency of a user's finger to the touch panel on the basis of an electrostatic capacitance produced between the first and the second resistive membranes and ground, the adjacency detecting part being connected with the touch panel electrically; a detection-mode switching control part configured to switch an operating mode of the input device between one condition where the input position detecting unit is operating and another condition where the adjacency detecting part is operating, the detection-mode switching control part being connected with the input position detecting unit and the adjacency detecting part; and a resistive membrane connecting part configured to electrically connect the first resistive membrane with the second resistive membrane when the adjacency detecting part is operating.

According to the second aspect of the present invention, there is also provided an electronic device comprising: an input device including a touch panel including a first resistive membrane and a second resistive membrane, an input position detecting unit configured to detect an input position onto the touch panel when the first resistive membrane makes contact with the second resistive membrane, the input position detecting unit being connected with the touch panel electrically, an adjacency detecting part configured to detect an adjacency of a user's finger to the touch panel on the basis of an electrostatic capacitance produced between the first and the second resistive membranes and ground, the adjacency detecting part being connected with the touch panel electrically, a detection-mode switching control part configured to switch an operating mode of the input device between one condition where the input position detecting unit is operating and another condition where the adjacency detecting part is operating, the detection-mode switching control part being connected with the input position detecting unit and the adjacency detecting part, and a resistive membrane connecting part configured to electrically connect the first resistive membrane with the second resistive membrane when the adjacency detecting part is operating; an on-screen display generating unit configured to generate on-screen display signals, the on-screen display generating unit being electrically connected with the input device; a display unit configured to display an image on which an on-screen display based on the on-screen display signals is superimposed, the display unit being electrically connected with the on-screen display generating unit; and an operation control part configured to allow the on-screen display generating unit to generate the on-screen display signals, the operation control part being electrically connected with the on-screen display generating unit, wherein the operation control part allows the on-screen display generating unit to generate the on-screen display signals when the adjacency detecting part of the input device detects an adjacency of a user's finger to the touch panel.

### BRIEF DESCRIPTION OF THE DRAWINGS

FIG. 1 is a block diagram showing an embodiment of the present invention;

FIG. 2 is an external view showing a touch panel in accordance with an embodiment of the present invention;

FIG. 3 is a schematic structural view showing the touch panel of an embodiment of the present invention;

FIG. 4 is a structural view showing the touch panel and a control unit of an embodiment of the present invention;

FIG. 5 is a flow chart explaining a adjacency detection mode in accordance with an embodiment of the present invention; and

FIG. 6 is a flow chart explaining the operation of an electronic device in accordance with an embodiment of the present invention.

### DETAILED DESCRIPTION OF THE PREFERRED EMBODIMENTS

An input device and an electronic device using the input device of the present invention will be described below with reference to accompanying drawings.

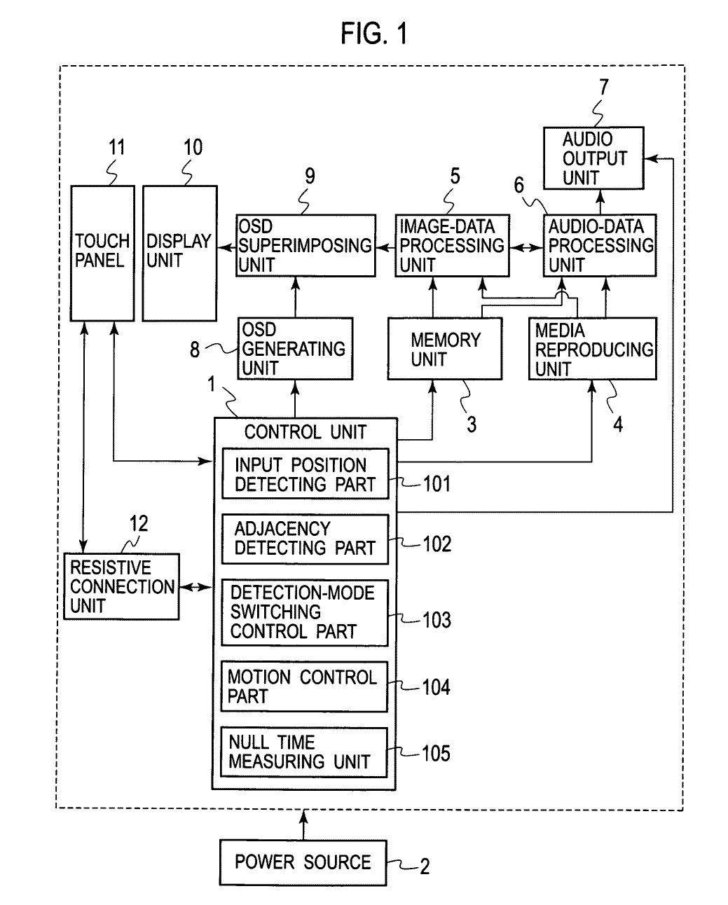

FIG. 1 illustrates an image-and-sound reproducing device as an electronic device. A control unit 1 includes an input position detecting part 101, an adjacency detecting part 102, a detection-mode switching control part 103, an operation control part 104 and a null time measuring unit 105. The control unit 1 may be formed by a microprocessor, for example. A single microprocessor may constitute the control unit 1. Alternatively, a plurality of microprocessors may constitute the control unit 1.

Under control of the operation control part 104, a memory unit 3 or a media reproducing unit 4 outputs image data to the image-data processing unit 5. Under the control of the operation control part 104, additionally, the memory unit 3 or the media reproducing unit 4 outputs audio data to the audio-data processing unit 6. For instance, the memory unit 3 is formed by a hard-disc drive (HDD), while the media reproducing unit 4 is formed by an optical-disc drive.

The image-data processing unit 5 converts the inputted image data to video signals, such as RGB signals. In addition, the image-data processing unit 5 outputs the video signals to an on-screen display (OSD) superimposing unit 9.

On the other hand, the audio-data processing unit 6 converts the inputted audio data to sound signals, such as analogue sound signals. Then, the audio-data processing unit 6 outputs the sound signals synchronized with the video signals to an audio output unit 7. For example, the audio output unit 7 comprises a speaker (or speakers) and an amplifier. The audio output unit 7 operates to reproduce the inputted sound signals.

The magnitude of sound outputted from the audio output unit 7 is controlled by the operation control part 104 of the control unit 1.

An on-screen display (OSD) generating unit 8 generates OSD signals based on the control of the operation control part 104 and further outputs them to the OSD superimposing unit 9.

The OSD superimposing unit 9 superimposes the OSD signals on the video signals outputted from the image-data processing unit 5 and successively outputs the resulting signals to a display unit 10. Then, the display unit 10 displays the video signals (i.e. video image) on which the OSD signals supplied from the OSD superimposing unit 9 are superimposed. A power source 2 is adapted so as to supply respective parts with electrical power. With this laminate structure, it is possible to allow on-screen displays (OSD) 21-24 displayed on the display unit 10 to correspond to respective input positions to the touch panel 11.

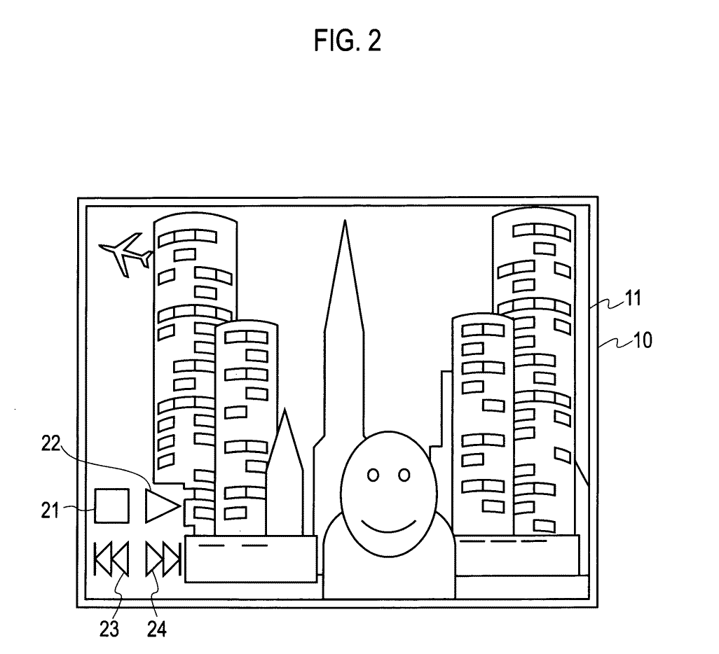

Using FIG. 2, an exemplary operation of the electronic device when a user manipulates the touch panel 11 will be described below. Suppose that the electronic device is operating in an input position detecting mode described later. The touch panel 11 is overlaid on the display unit 10.

When a user touches the touch panel 11, the input position detecting unit 101 detects an input position at which the user touches the touch panel 11. If the input position detected by the input position detecting unit 101 coincides with a position on the OSD 21 for stop, then the operation control part 104 stops the operation of the electronic device of displaying an image based on contents data or outputting sounds based thereon. That is, the operation control part 104 brings the device's condition of reproducing the contents data to a stand. When the contents data is not reproduced, the operation control part 104 executes no operation.

If the input position detected by the input position detecting unit 101 coincides with a position on the OSD 22 for play, then the operation control part 104 allows the respective parts to execute the operation of reproducing the contents data. If the content data is being reproduced, the operation control part 104 executes no operation.

If the input position detected by the input position detecting unit 101 coincides with a position on the OSD 23 for returning a chapter, then the operation control part 104 starts the operation of reproducing the previous chapter to a chapter including the contents data being reproduced at present, from the beginning. On the contrary, when no contents data or the first chapter is being reproduced, the operation control part 104 executes no operation.

If the input position detected by the input position detecting unit 101 coincides with a position on the OSD 24 for advancing a chapter, then the operation control part 104 starts the operation of reproducing the next chapter to a chapter including the contents data being reproduced at present, from the beginning. On the contrary, when no contents data or the last chapter is being reproduced, the operation control part 104 executes no operation.

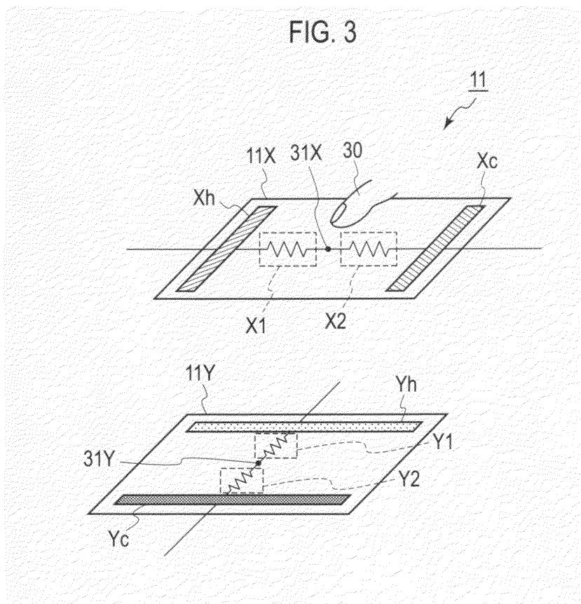

Next, the structure of the touch panel 11 will be described with reference to FIG. 3. The touch panel 11 includes a resistive membrane 11X having electrodes located on both sides thereof and a Y-directional resistive membrane 11Y having electrodes located on upper and lower sides thereof. In the resistive membrane 11X, the electrodes are arranged so as to extend up and down in the display unit 10 (FIG. 2), as shown in the FIG. 3. While, in the resistive membrane 11Y, the electrodes are arranged so as to extend right and left in the display unit 10. The resistive membranes 11X, 11Y may be formed by transparent conductive films which are produced by coating indium tin on a transparent film, for example.

Between the electrode Xh and the electrode Xc of the resistive membrane 11X and between the electrode Yh and the electrode Yc of the resistive membrane 11Y, there are electrical resistances composed of conducting films.

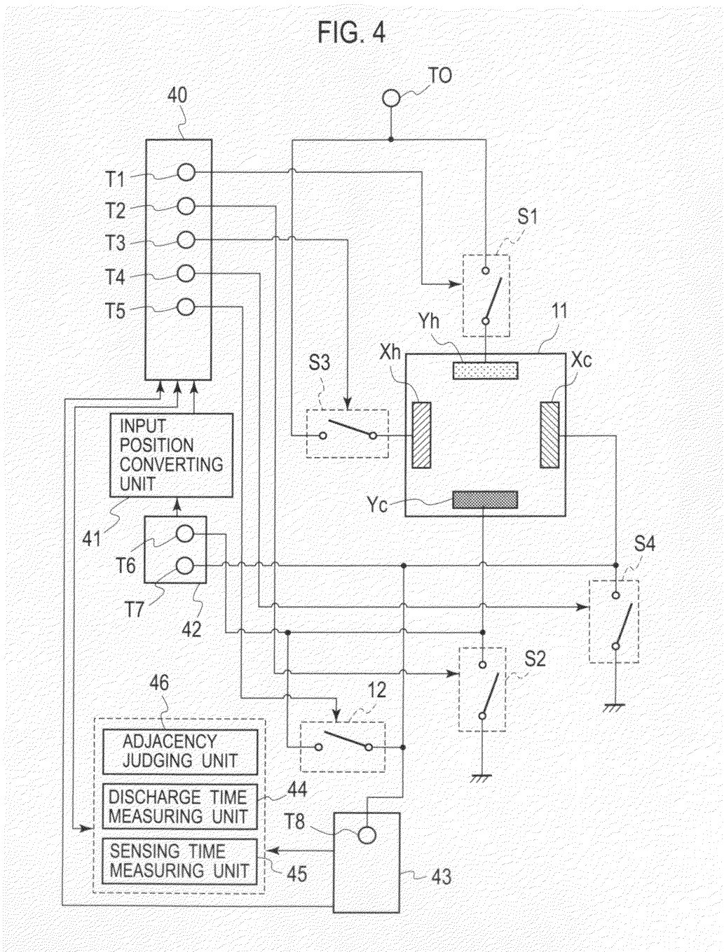

Referring to FIG. 4, the connection among the control unit 1, the touch panel 11 and a resistive membrane connecting part 12 will be described below.

In the touch panel 11, the electrode Xh of the resistive membrane 11X is electrically connected to a positive (+) terminal T0 of the power source 2 through a switch S3. The electrode Xc of the resistive membrane 11X is electrically connected to a Y-position detecting terminal T7 of a first voltage measuring unit 42. Again, the electrode Xc of the resistive membrane 11X is also connected to ground through a switch S4 electrically.

In the touch panel 11, additionally, the electrode Yh of the resistive membrane 11Y is electrically connected to the positive terminal T0 of the power source 2 through a switch S1. The electrode Yc of the resistive membrane 11Y is electrically connected to an X-position detecting terminal T6 of the first voltage measuring unit 42. Again, the electrode Yc of the resistive membrane 11Y is also connected to ground through a switch S2 electrically. For example, the switches S1 to S4 may be formed by transistors.

Further, the electrode Xc of the resistive membrane 11X is electrically connected to the electrode Yc of the resistive membrane 11Y through the resistive membrane connecting part 12. For example, the resistive membrane connecting part 12 may be formed by an analogue switch. The electrode Xc is also connected to an adjacency detecting terminal T8 of a second voltage detecting unit 43. The electrode Yc is electrically connected to the adjacency detecting terminal T8 of the second voltage detecting unit 43 when the resistive membrane connecting part 12 is switched on.

In operation, a switch control unit 40 outputs switch control signals from switch control terminals T1 to T5, performing the on/off control of the switches S1 to S4 and the resistive membrane connecting part 12.

Next, the input-position detection mode of detecting an input position at which a user touches the touch panel 11 will be described with reference to FIGS. 3 and 4. In FIG. 4, the switch control unit 40 functions as the detection-mode switching control part 103 of FIG. 1. In addition, part of the switch control unit 40 for controlling the switches S1 to S4, an input position converting unit 41 and the first voltage measuring unit 42 all function as the input position detecting unit 101 of FIG. 1.

When switching from an adjacency detection mode mentioned later to the input-position detection mode, the switch control unit 40 switches on the switches S3 and S4 and switches off the switches S1 and S2 and the resistive membrane connecting part 12. Note that such a situation corresponds to a condition of standing ready to detection of the input position in the horizontal direction of the touch panel 11.

Under this condition, if a user's finger 30 touches a specified position (point) 31X of the touch panel, the point 31X of the resistive membrane 11X comes into contact with a certain position (point) 31Y of the resistive membrane 11Y, which is located immediately below the point 31X. Through the intermediary of the resistive membrane 11Y, consequently, the first voltage measuring unit 42 detects a voltage value obtained as a result of dividing a voltage (potential difference) between the electrodes Xh, Xc by one resistance X1 extending from the electrode Xh to the point 31X and another resistance X2 extending from the point 31X to the electrode Xc, and outputs the detected voltage value to the input position converting unit 41. Then, the input position converting unit 41 converts the detected voltage value to a position in the horizontal direction of the touch panel 11, and outputs the converted position to the switch control unit 40.

On receipt of the position in the horizontal direction of the touch panel 11 from the input position converting unit 41, the switch control unit 40 switches on the switches S1 and S2, and switches off the switches S3 and S4. The resistive membrane connecting part 12 still remains in its off-state. Note that such a situation corresponds to a condition of detecting the input position in the vertical direction of the touch panel 11.

Under this condition, through the intermediary of the resistive membrane 11X, the first voltage measuring unit 42 detects a voltage value obtained as a result of dividing a voltage (potential difference) between the electrodes Yh, Yc by one resistance Y1 extending from the electrode Yh to the point 31Y and another resistance Y2 extending from the point 31Y to the electrode Yc, and outputs the detected voltage value to the input position converting unit 41. Then, the input position converting unit 41 converts the detected voltage value to a position in the vertical direction of the touch panel 11, and outputs the converted position to the switch control unit 40.

In the input-position detection mode, after detecting the input position in the horizontal direction, the switch control unit 40 instantly switches on the switches S1 and S2, and further switches off the switches S3 and S4 to bring the control unit 1 into the condition of detecting the input position in the vertical direction, as mentioned above. In this way, the part of the switch control unit 40 for controlling the switches Si to S4, the input position converting unit 41 and the first voltage measuring unit 42 all function as the input position detecting unit 101.

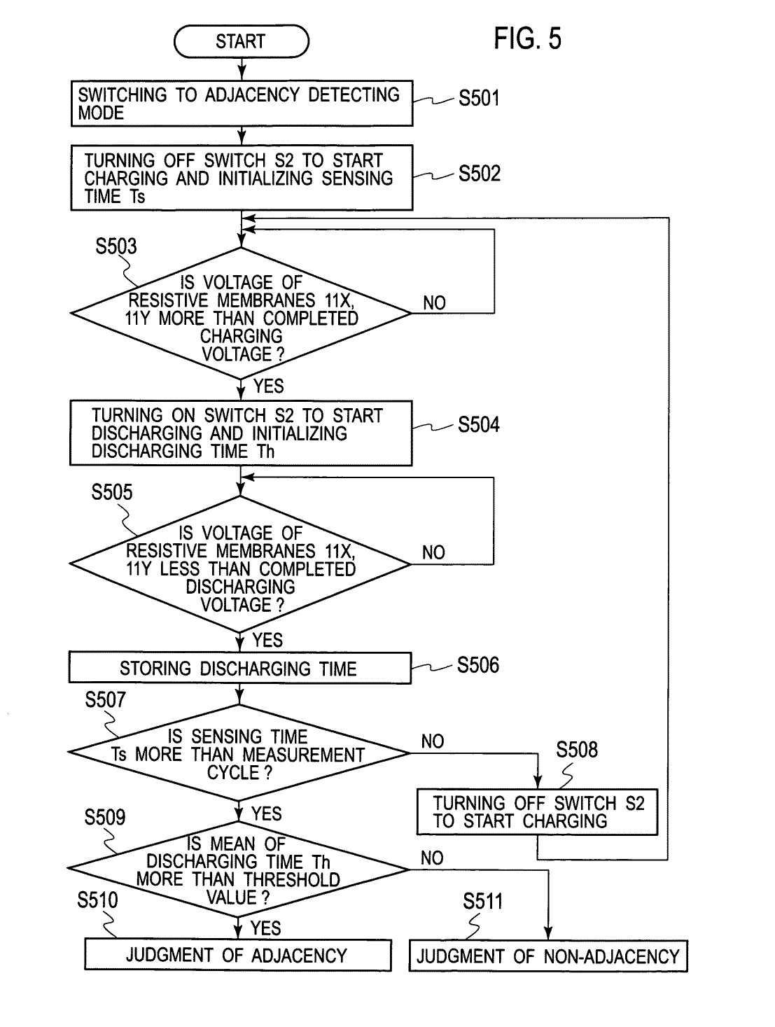

Next, the adjacency detecting mode of judging whether the user's finger 30 is approaching the touch panel 11 or not will be described with reference to FIG. 4 and the flow chart of FIG. 5. As mentioned above, the switch control unit 40 functions as the detection-mode switching control part 103. Further, the part of the switch control unit 40 for controlling the switches S1 and S2, the second voltage detecting unit 43, a discharge time measuring unit 44, a sensing time measuring unit 45 and an adjacency judging unit 46 all function as the adjacency detecting part 102 with the execution of an operation described later.

At step S501, the detection-mode switching control part 103 switches the operation mode to the adjacency detecting mode. In detail, at step S501, the switch control unit 40 turns on the switches S1, S2 and the resistive membrane connecting part 12 while turning off the switches S3, S4, thereby changing the detecting mode to the adjacency detecting mode. Then, the resistive membrane connecting part 12 electrically connects the resistive membrane 11X with the resistive membrane 11Y. In this regard, it is desirable to connect the resistive membrane 11X with the resistive membrane 11Y so that they are shunted each other in short-circuit. However, a resistance may be present between the resistive membrane 11X and the resistive membrane 11Y as long as the resistance is less than a few hundred ohm or so.

In this embodiment, when the operation mode is the adjacency detecting mode, it is performed to connect the resistive membranes 11X, 11Y with the first voltage measuring unit 42. Alternatively, even when the operation mode is the adjacency detecting mode, the resistive membranes 11X, 11Y may be disconnected from to the first voltage measuring unit 42. In such a case, as the electrostatic capacitance is reduced between the resistive membranes 11X, 11Y and ground, it is possible to detect a change in electrostatic capacitance due to approaching of the finger more precisely.

At next step S502, the switch control unit 40 turns off the switch S2 to start electrical charging into a capacitor composed of the resistive membranes 11X, 11Y and ground. With the start of electrical charging, additionally, the sensing time measuring unit 45 initializes a sensing time Ts, that is, zero, and starts the measurement of the sensing time Ts.

At next step S503, the second voltage detecting unit 43 measures a voltage value between the resistive membranes 11X, 11Y and ground. Then, the adjacency judging unit 46 judges whether the measured voltage value is more than a voltage value representing a completion of charging, which will be referred to as “completed charging voltage”. At step S503, if it is judged that the measured voltage value is less than the completed charging voltage (No), then the operation at step S503 is repeated. On the other hand, if it is judged that the measured voltage value is equal to or more than the completed charging voltage (Yes), the adjacency judging unit 46 judges that the charging operation has been completed. Thereafter, the routine goes to step S504.

At next step S504, the switch control unit 40 turns on the switch S2 to start discharging of electrical charge accumulated in the capacitor composed of the resistive membranes 11X, 11Y and ground. With the start of electrical discharging, additionally, the discharge time measuring unit 44 initializes a discharge time Th, that is, zero, and starts the measurement of the discharge time Th. At next step S505, the second voltage detecting unit 43 measures a voltage value between the resistive membranes 11X, 11Y and ground. Then, the adjacency judging unit 46 judges whether the measured voltage value is more than a voltage value representing a completion of discharging, which will be referred to as “completed discharging voltage”. At step S505, if it is judged that the measured voltage value is more than the completed discharging voltage (No), then the operation at step S505 is repeated. On the other hand, if it is judged that the measured voltage value is equal to or less than the completed discharging voltage (Yes), the adjacency judging unit 46 judges that the discharging operation has been completed. Thereafter, the routine goes to step S506.

At step S506, the adjacency judging unit 46 stores a discharging time (duration) into a not-shown memory. Note that the discharging time is a duration required for the voltage value between the resistive membranes 11X, 11Y and ground to change from the completed charging voltage to the completed discharging voltage.

At next step S507, the adjacency judging unit 46 judges whether the sensing time Ts measured by the sensing time measuring unit 45 is equal to or more than a measurement cycle or not. In this embodiment, for example, 20 mS (microsecond) is set for the measurement cycle. Note that the measurement cycle is a time cycle by which the adjacency detecting part 102 judges whether the finger 30 is approaching the touch panel 11 or not, repeatedly. That is, in this embodiment, it is performed to judge whether the finger 30 is approaching the touch panel 11 or not, with respect to each 20 ms.

If it is judged at step S507 that the sensing time measuring unit 45 is less than the measurement cycle (No), the routine goes to step S508. At step S508, the switch control unit 40 turns off the switch S2 to restart the electrical charging into the capacitor composed of the resistive membranes 11X, 11Y and ground. Thereafter, the routine returns to step S503. In this way, the measurement of discharge time is repeated until the sensing time reaches the measurement cycle.

If it is judged at step S507 that the sensing time measuring unit 45 is equal to or more than the measurement cycle (Yes), then the routine goes to step S509 where the adjacency judging unit 46 averages the discharging time measured during one measurement cycle, and further judges whether or not a mean (average) of the discharging time is equal to or more than a predetermined threshold value. It is generally noted that if a user's finger or the like is positioned adjacent to the touch panel 11, the discharge time would be apt to be elongated due to electrical charge that the finger possesses. If the judgment at step S509 is Yes, that is, the mean is equal to or more than the predetermined threshold value, then the routine goes to step S510 where the adjacency judging unit 46 judges that the user's finger 30 is approaching the touch panel 11 right now. If it is judged that the mean is less than the predetermined threshold value (No), then the routine goes to step S511 where the adjacency judging unit 46 judges that the user's finger 30 is not approaching the touch panel 11.

That's how the adjacency detecting part 102 executes during one measurement cycle. In case of performing the adjacency detection continuously, the routine returns to step S502 (by the adjacency detecting part 102) where the above-mentioned operation is repeated. As mentioned above, according to the embodiment, the judgment whether or not the finger 30 is approaching the touch panel 11 is accomplished on the basis of the average of discharging time in the measurement cycle. Alternatively, the judgment may be accomplished on the basis of the total of discharge time in the measurement cycle.

In this way, according to the embodiment, two resistive membranes 11X, 11Y are electrically connected with each other in utilizing these resistive membranes of the resistive touch panel as an adjacency sensor. Therefore, as there is no possibility that the resistive membranes become noise sources mutually, it is possible to detect an adjacency of a user's finger to the touch panel precisely in comparison with the conventional resistive touch panel where two resistive membranes are not connected with each other. In other words, according to the embodiment, with its enhanced detection sensitivity, the input device of the present invention is capable of detecting the adjacency of a user's finger 30 even when it is far from the touch panel 11 by several centimeters. Regarding this electrical connection between the resistive membrane 11X and the resistive membrane 11Y, it is desirable to connect the former with the latter in a short circuit. Nevertheless, there may exist a resistance between the resistive membrane 11X and the resistive membrane 11Y as long as the resistance has an ohmic value less than a few hundred ohm.

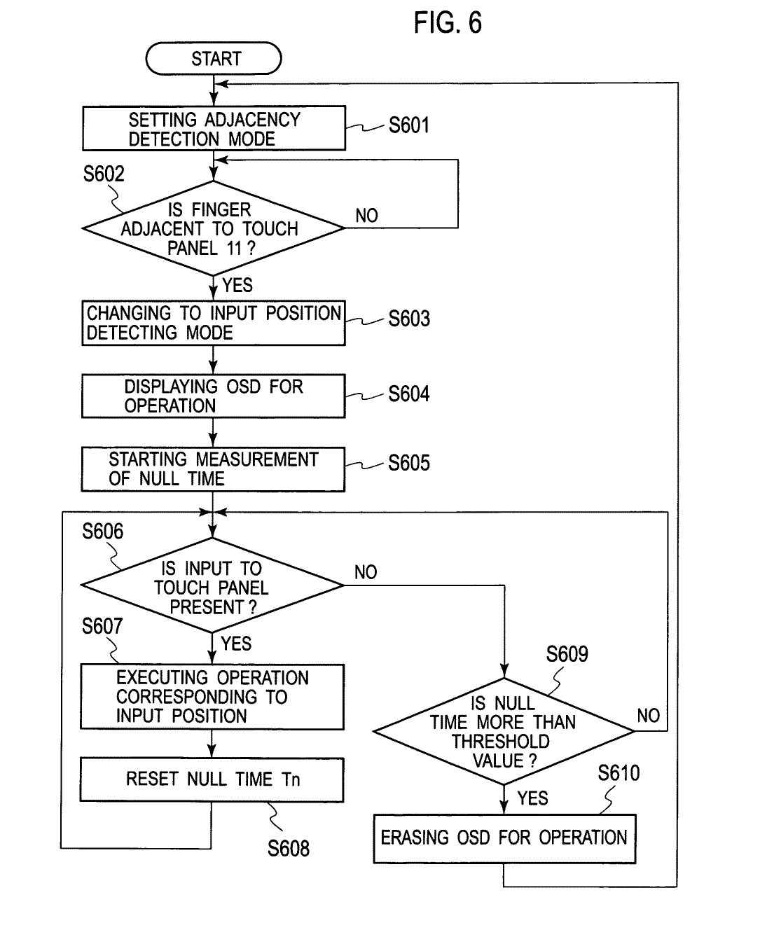

Next, the operation of the electronic device of this embodiment will be described with reference to a flow chart of FIG. 6. When the power source 2 of FIG. 1 is turned on, that is, the electronic device is powered on, the detection-mode switching control part 103 sets the detection mode to the adjacency detection mode at step S601. When the electronic device is in the adjacency detection mode, the resistive membrane connecting part 12 connects the resistive membrane 11X with the resistive membrane 11Y.

At next step S602, the adjacency detecting part 102 judges whether the user's finger 30 is approaching the touch panel 11 or not. If the judgment at step S602 is No, that is, the finger is not approaching the touch panel 11, the operation at step S602 is repeated.

If it is judged that the finger 30 is approaching the touch panel 11, that is, the judgment of “Yes” at step S602, the routine goes to step S603 where the detection-mode switching control part 103 changes the detection to the input position detecting mode. That is, the detection-mode switching control part 103 controls the switches S1 to S4 and the resistive membrane connecting part 12 in the above-mentioned way, thereby activating the input-position detecting function of the input position detecting unit 101 while inactivating the adjacency detecting function of the adjacency detecting part 102. As a matter of course, when the electronic device is in the input position detecting mode, the resistive membrane connecting part 12 does not connect the resistive membrane 11X with the resistive membrane 11Y electrically.

At next step S604, the operation control part 104 of the control unit 1 generates the OSD (on-screen display) signals to allow the OSD generating unit 8 to display the OSD 21 for stop, the OSD 22 for play, the OSD 23 for returning a chapter and the OSD 24 for advancing a chapter. The OSD generating unit 8 outputs the OSD signals to the OSD superimposing unit 9. Then, the OSD superimposing unit 9 superimposes the OSD signals on the video signals outputted from the image-data processing unit 5 and successively outputs the resulting signals to the display unit 10. Then, the display unit 10 displays the video signals having the OSD signals for the OSD 21, the OSD 22, the OSD 23 and the OSD 24 superimposed thereon, which have been supplied from the OSD superimposing unit 9.

At next step S605, the null time measuring unit 105 starts measurement of a null time Tn. Note that “null time” represents a period when the touch panel 11 has no input.

At next step S606, the input position detecting unit 101 judges whether there is an input onto the touch panel 11 or not. If it is judged that there is an input onto the touch panel 11 (Yes), then the routine goes to step S607. On the other hand, if it is judged that there is no input onto the touch panel 11 (No), then the routine goes to step S609. Here, it is noted that the electronic device is in the input position detecting mode at the time of executing the operation at step S606. Therefore, the condition of having an input at this moment corresponds to a state where the resistive membranes 11X, 11Y are being electrically connected with each other by a user's manipulation.

At step S607, the input position detecting unit 101 detects an input position, while the operation control part 104 allows respective parts of the electronic device to perform their operations corresponding to the input position detected by the input position detecting unit 101.

At next step S608, the null time measuring unit 105 resets the null time Tn to zero and thereupon, restarts the measurement of the null time Tn.

At step S609 in case of the judgment of “No” at step S606, the null time measuring unit 105 judges whether the null time Tn is equal to or more than a predetermined threshold value, or not. In this embodiment, for example, 10 seconds is established for this threshold value. If it is judged that the null time Tn is less than the threshold value (No), the routine goes to step S606. On the other hand, if it is judged that the null time Tn is equal to or more than the threshold value (Yes), the routine goes to step S610.

At step S610, the operation control part 104 of the control unit 1 allows the OSD generating unit 8 to stop generating of the OSD signals. Consequently, the display unit 10 displays the video signals having no OSD signal superimposed thereon. Thereafter, the routine returns to step S601.

In this way, according to the embodiment, owing to the adoption of the touch panel 11 as an adjacency sensor, it is possible to detect such a situation that a user's finger 30 is approaching the touch panel 11. Consequently, it is possible to make the input device available to various applications, for example, automatic displaying of OSD for manipulation upon detection of the adjacency of the user's finger 30 during displaying of images, as mentioned above.

It will be understood by those skilled in the art that the foregoing descriptions are nothing but an embodiment of the disclosed input device and the disclosed electronic device using the above input device and therefore, various changes and modifications may be made without departing from the scope of the invention. For example, although the above-mentioned embodiment presupposes that the manipulation to the touch panel 11 is carried out by the user's finger 30, the manipulated input to the touch panel 11 may be performed by any element other than the user's finger 30. Thus, if adopting the input device and the electronic device of the present invention., then it is also possible to detect such a situation that any element other than the user's finger 30 is approaching the touch panel 11. Further, although an electrostatic capacitance (i.e. a change in capacitance caused by an adjacency of the user's finger 30) is detected by measuring the discharge time in the above-mentioned embodiment, a variety of known methods may be adopted to detect an electrostatic capacitance.

What is claimed is:

1. An input device comprising:
a touch panel including a first resistive membrane and a second resistive membrane;
an input position detecting unit configured to detect an input position onto the touch panel when the first resistive membrane makes contact with the second resistive membrane, the input position detecting unit being connected with the touch panel electrically;
an adjacency detecting part configured to detect an adjacency of a user's finger to the touch panel on the basis of an electrostatic capacitance produced between the first and the second resistive membranes and ground, the adjacency detecting part being connected with the touch panel electrically;
a detection-mode switching control part configured to switch an operating mode of the input device between one condition where the input position detecting unit is operating and another condition where the adjacency detecting part is operating, the detection-mode switching control part being connected with the input position detecting unit and the adjacency detecting part; and
a resistive membrane connecting part configured to electrically connect the first resistive membrane with the second resistive membrane when the adjacency detecting part is operating.

2. The input device of claim 1, wherein the resistive membrane connecting part electrically connects the first resistive membrane with the second resistive membrane so that they are shunted each other in short-circuit when the adjacency detecting part is operating.

3. The input device of claim 1, wherein the adjacency detecting part judges whether the user's finger is approaching the touch panel or not, based on an average of discharge time of electrical charge in a predetermined measurement cycle, the electrical charge being accumulated in a capacitor composed of the first and the second resistive membranes and ground.

4. The input device of claim 1, wherein the adjacency detecting part judges whether the user's finger is approaching the touch panel or not, based on a total of discharge time of electrical charge in a predetermined measurement cycle, the electrical charge being accumulated in a capacitor composed of the first and the second resistive membranes and ground.

5. An electronic device comprising:
an input device including:
a touch panel including a first resistive membrane and a second resistive membrane;
an input position detecting unit configured to detect an input position onto the touch panel when the first resistive membrane makes contact with the second resistive membrane, the input position detecting unit being connected with the touch panel electrically;
an adjacency detecting part configured to detect an adjacency of a user's finger to the touch panel on the basis of an electrostatic capacitance produced between the first and the second resistive membranes and ground, the adjacency detecting part being connected with the touch panel electrically;
a detection-mode switching control part configured to switch an operating mode of the input device between one condition where the input position detecting unit is operating and another condition where the adjacency detecting part is operating, the detection-mode switching control part being connected with the input position detecting unit and the adjacency detecting part; and
a resistive membrane connecting part configured to electrically connect the first resistive membrane with the second resistive membrane when the adjacency detecting part is operating;
an on-screen display generating unit configured to generate on-screen display signals, the on-screen display generating unit being electrically connected with the input device;
a display unit configured to display an image on which an on-screen display based on the on-screen display signals is superimposed, the display unit being electrically connected with the on-screen display generating unit; and
an operation control part configured to allow the on-screen display generating unit to generate the on-screen display signals, the operation control part being electrically connected with the on-screen display generating unit, wherein
the operation control part allows the on-screen display generating unit to generate the on-screen display signals when the adjacency detecting part of the input device detects an adjacency of a user's finger to the touch panel.

6. The electronic device of claim 5, wherein the resistive membrane connecting part electrically connects the first resistive membrane with the second resistive membrane so that they are shunted each other in short-circuit when the adjacency detecting part is operating.

7. The electronic device of claim 5, wherein the adjacency detecting part judges whether the user's finger is approaching the touch panel or not, based on an average of discharge time of electrical charge in a predetermined measurement cycle, the electrical charge being accumulated in a capacitor composed of the first and the second resistive membranes and ground.

8. The electronic device of claim 5, wherein the adjacency detecting part judges whether the user's finger is approaching the touch panel or not, based on a total of discharge time of electrical charge in a predetermined measurement cycle, the electrical charge being accumulated in a capacitor composed of the first and the second resistive membranes and ground.
